(19) United States
(12) Patent Application Publication
(10) Pub. No.: US 2015/0084350 A1
(43) Pub. Date: Mar. 26, 2015

(54) LOCKING STRUCTURE OF TRUNK LID

(71) Applicant: Hyundai Motor Company, Seoul (KR)

(72) Inventor: Keun-Soo Kim, Suwon-Si (KR)

(73) Assignee: Hyundai Motor Company, Seoul (KR)

(21) Appl. No.: 14/106,753

(22) Filed: Dec. 14, 2013

(30) Foreign Application Priority Data
Sep. 26, 2013 (KR) 10-2013-0114178

(51) Int. Cl. E05B 83/18

(52) U.S. Cl. CPC E05B 83/18
USPC 292/194

(57) ABSTRACT

A locking structure of a trunk lid opens and closes a trunk space in accordance with the rotation of a trunk hinge connected to a vehicle body, the trunk lid being connected to the trunk hinge. The structure includes a striker connected to the trunk hinge; and a latch for restricting the movement of the striker when the striker is fastened, wherein the latch is mounted to a location where the latch is fastened to the striker while the trunk lid connected to a vehicle body is closed. The placement of the striker allows an enlarged trunk space by deleting the striker and the surrounding components and further the latch is not exposed outside thereby to improve appearance commerciality of a vehicle.

### CROSS-REFERENCE TO RELATED APPLICATION

The present application claims priority of Korean Patent Application Number 10-2013-0114178 filed Sep. 26, 2013, the entire contents of which application is incorporated herein for all purposes by this reference.

### BACKGROUND OF INVENTION

1. Field of Invention

The present disclosure relates to a locking structure of a trunk lid, and more particularly, to a locking structure of trunk lid, in which a striker and a latch are arranged to a vehicle body of a front of the trunk lid (in more detail, rear package tray) unnotedly by a user thereby to improve commerciality of a vehicle and to enlarge a size of a trunk space.

2. Description of Related Art

Generally, a trunk space of a passenger car is a space at which luggage is deposited and which is provided a rear space of a rear seat.

The trunk space, as shown in FIG. 1, is opened and closed with a trunk lid 5 that is connected rotatively to a vehicle body through a trunk hinge 4.

The shape and configuration of the trunk lid 5 may be varied depending on the designs and kinds of a vehicle, but the trunk lid 5 of a sedan type-vehicle is shaped to be bent to cover an upper side and a rear side of the trunk space at a rear of a package tray 6.

Further, the trunk lid 5 is connected a pup-up device such as a gas lifter and torsion bar, etc., so as to be pup-upped to a predetermined height wherein the trunk lid is locked by being connected to a latch 1 that is connected to a striker 2 in a ring shape mounted to a rear panel of a vehicle body and a remote end of the trunk lid 5.

However, according to a conventional configuration the latch mounted to the trunk lid 5 and the striker 2 mounted to a vehicle body are exposed outside (to be noted easily by a user) to make appearance unharmonious and further a wire 3 for opening the latch 1 is connected to the trunk hinge 4, causing to make the appearance unharmonious.

Furthermore, the wire 3 is to be twisted or operation forces of a handle (connected to the wire for releasing the latch) are to be different in accordance with workmanship of an operator.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention have been made in an effort to solve the above-described problems associated with the prior art.

Various aspects of the present invention provide for a locking structure of a trunk lid to open and close a trunk space in accordance with the rotation of a trunk hinge one end of which is connected to a vehicle body, the trunk lid being connected to the other end of the trunk hinge, including: a striker connected to the trunk hinge; and a latch for restricting the movement of the striker when the striker is fastened, wherein the latch is mounted to a location where the latch is fastened to the striker while the trunk lid connected to a vehicle body is closed.

The latch may be mounted to a lower surface of a package tray, forming a part of a vehicle body, which is arranged to a front of the trunk lid at an upper side of a trunk space.

The latch and the striker may be arranged to form a pair wherein the pair of the latch and the striker is mounted to two trunk hinges arranged on both sides of the trunk lid, respectively, and the latches are connected to both sides of a rod connected to the wire, respectively, and the latches are controlled simultaneously to be fastened and released by pulling the wire.

The striker may have a bending bar shape wherein it includes two legs ends of which are connected to the trunk hinge and a fastening part that is connected to the respective leg and engaged with the latch, and the heights of the legs are different each other such that the fastening part is engaged vertically with the latch.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a trunk space mounted with a striker and a latch according to a related art;

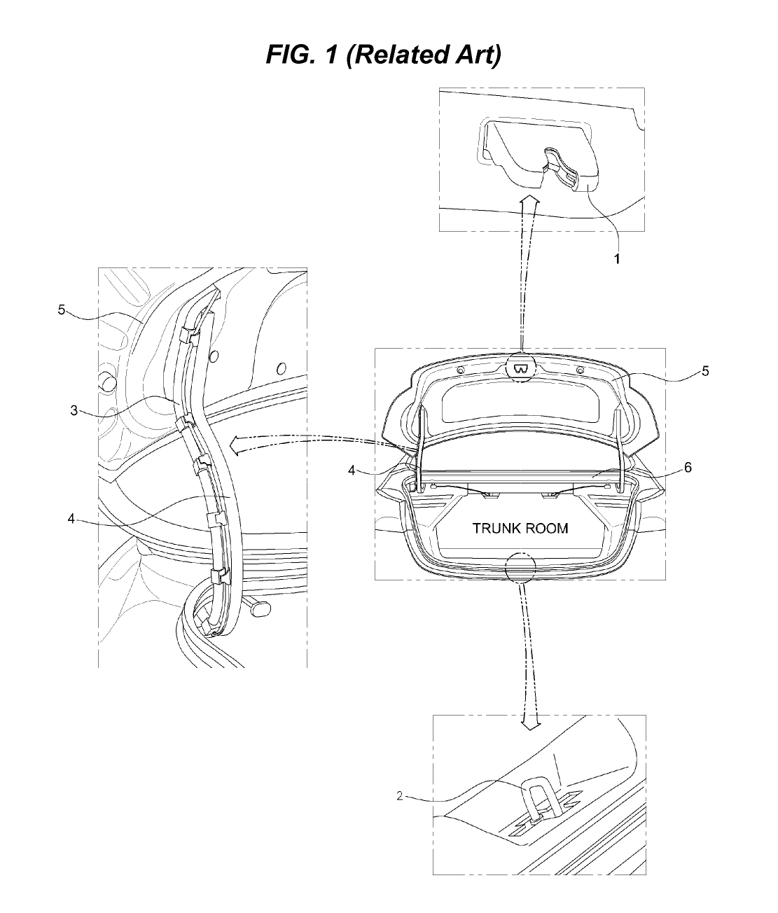

FIG. 2 is a side view showing a trunk space mounted with an exemplary striker and latch according to the present invention;

FIG. 3 is a side view showing an operation of an exemplary striker mounted to a trunk hinge in accordance with the opening and closing of a trunk lid according to the present invention;

FIG. 4 is a perspective view showing a trunk lid mounted with an exemplary striker according to the present invention with enlarged details showing each latch on both sides; and

FIG. 5 is a view showing an exemplary wire mounted to a vehicle body according to the present invention with an enlarged detail showing a wire connected to a latch according to the present invention; and

FIG. 6 is a view showing a comparison of an exemplary wire according to the present invention and a wire according to conventional art.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

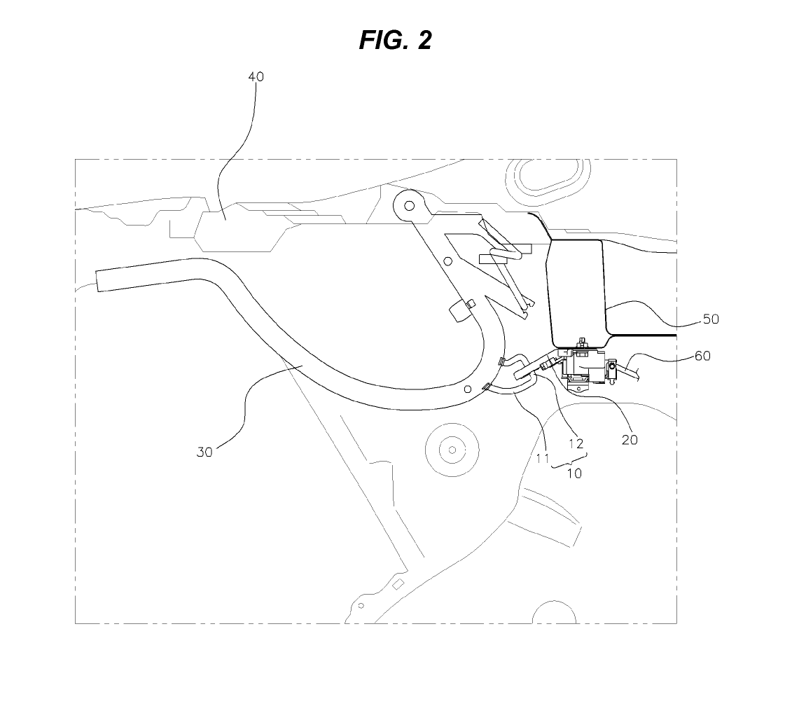

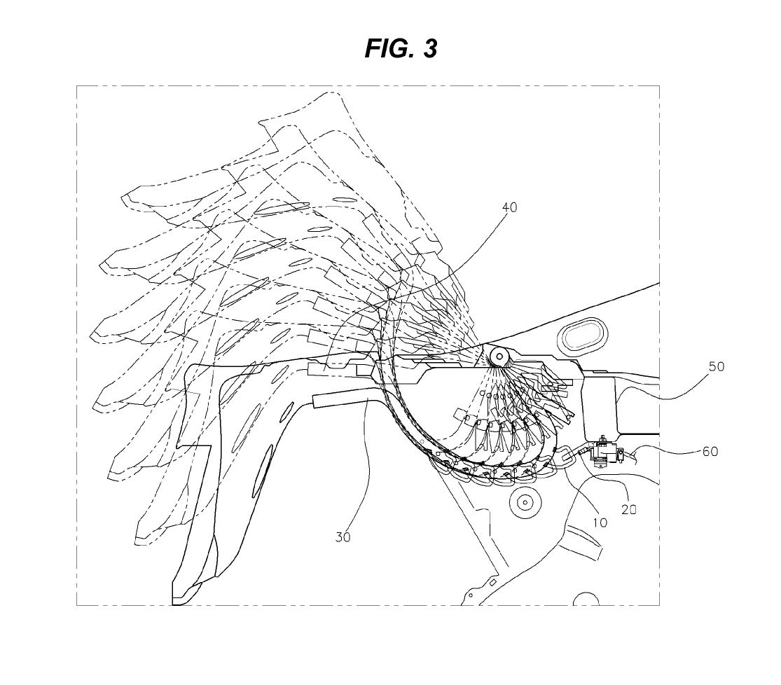

Referring to FIGS. 2 and 3, a trunk lid 40 according to the present invention is opened and closed by an operation of a trunk hinge 30 that is mounted rotatively to a vehicle body wherein a striker 10 is mounted to the trunk hinge 30 and a latch that is engaged with the striker 10 is mounted to a vehicle body.

The latch 20 is mounted to a vehicle body wherein the latch is mounted to a location where it is fastened to the striker 10 while the trunk lid is closed, that is, a lower surface of a package tray 60 (or quarter inter-panel), forming a part of a vehicle body, that is arranged to a front of the trunk lid 40 at an upper side of a trunk space (right side in FIGS. 2 and 3).

The striker 10 according to various embodiments of the present invention has a bending bar shape to form a “⊂” shape wherein it includes two legs ends of which are connected to the trunk hinge 30 and a fastening part 12 that is connected to the respective leg 11 and engaged with the latch 20. Here, the heights of the legs 11 are different each other such that the fastening part 12 enters vertically into the latch 20 to be engaged therewith.

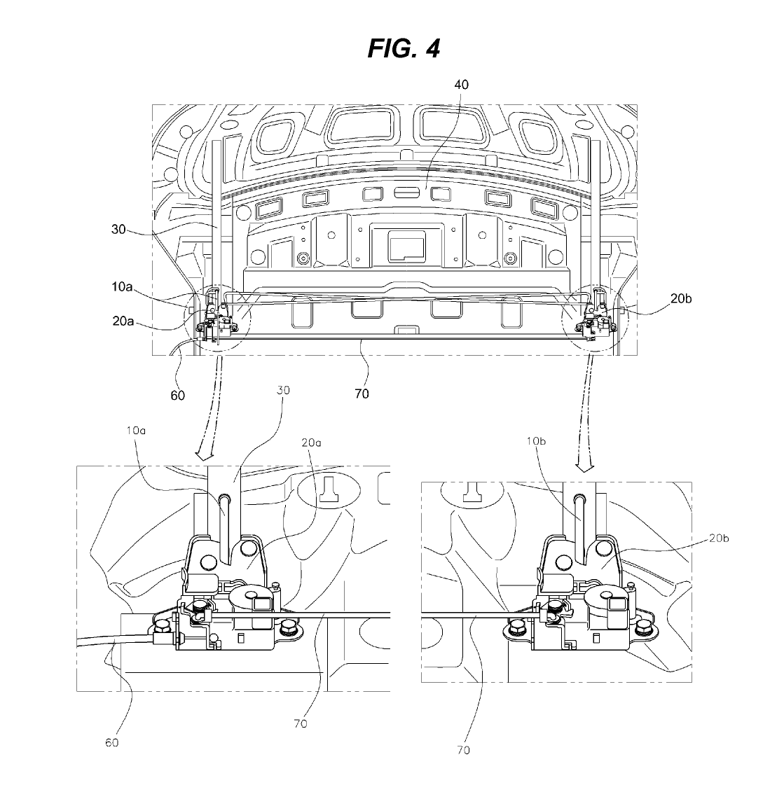

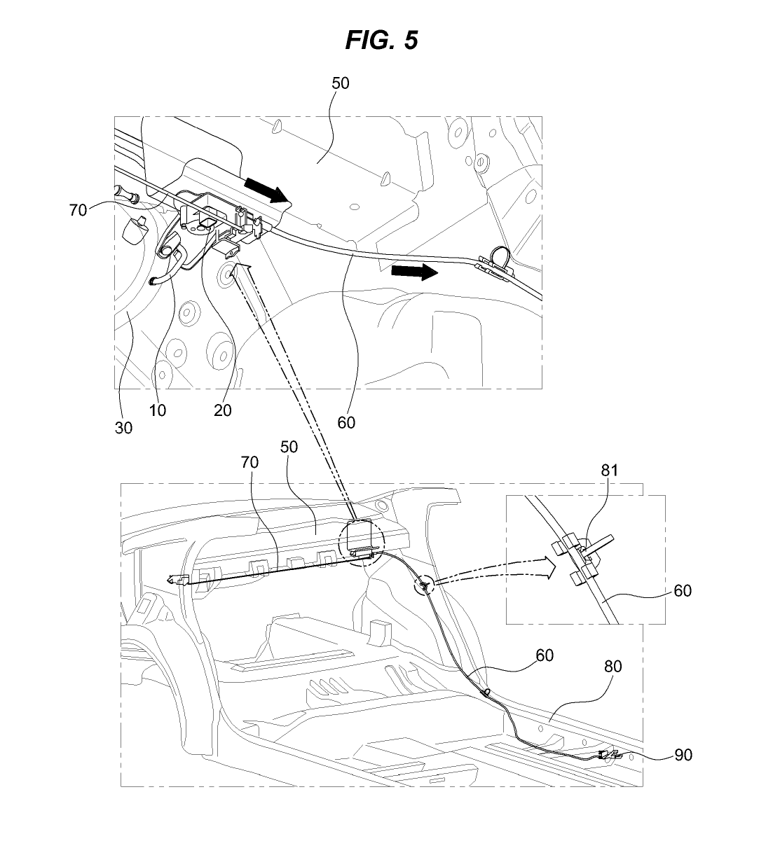

As shown in FIGS. 4 and 5, the latch 20 (20a, 20b) and the striker 10 (10a, 10b) are arranged as a pair on the respective trunk hinge 30 on both sides so as to provide uniform fastening force to both sides of the trunk lid 40.

According to the present invention, the trunk lid is opened and closed, like a conventional trunk lid, by pulling the wire 60 through an operation of a handle 90 disposed on a driver's seat wherein the latches 20a, 20b are connected to both sides of a rod connected to the wire 60, respectively, and the latches 20a, 20b are controlled simultaneously to be fastened and released by pulling the wire 60.

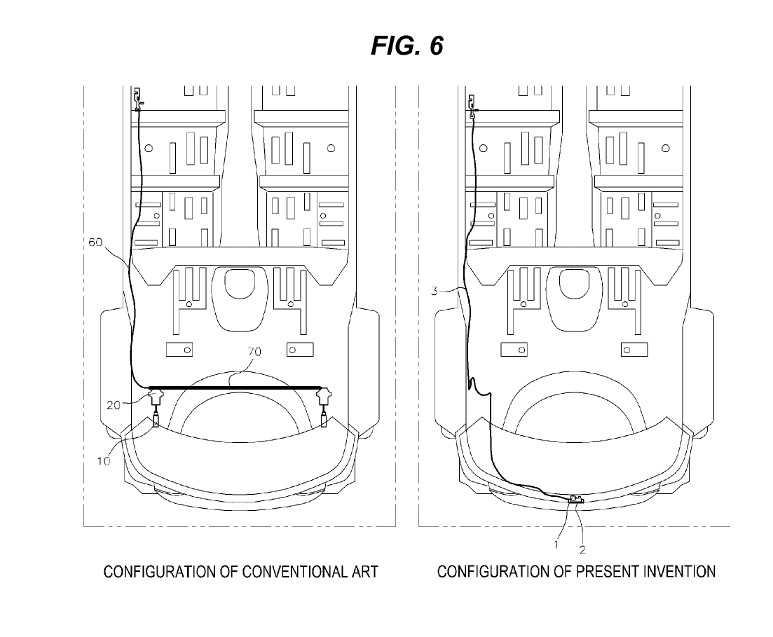

Accordingly, the both latches 20a, 20b are operated simultaneously by the wire 60 connected to the rod 70 and thus the wire 60 can be arranged in straight line relatively, as shown in FIG. 6, comparing to the conventional art. That is, the wire 60 can be arranged in a straight line to a vehicle body 80, which runs from the handle 90 provided on a driver's seat to a point where the rod 70 is disposed, using a clip 81.

As a result, the scattering of the operation force of the handle 90, which is caused in accordance with (workmanship of an operator) in the conventional art, can be minimized and the wire 60 is fixed to a vehicle body to improve the convenience of assembly and durability thereof, comparing to a conventional case where the wire is fixed to a trunk hinge and thus it is bent in accordance with opening and closing of the trunk lid.

Accordingly, according to the present invention, the latch 20 and the striker 10 are arranged unnotedly in the trunk space thereby to improve commerciality of a vehicle, convenience of assembly and durability thereof.

According to the present invention, the striker that has been mounted to a rear of a vehicle body under a conventional art is moved thereby to enlarge a size of a trunk space by deleting the striker and the surrounding components and further the latch is not exposed outside thereby to improve appearance commerciality of a vehicle.

Further, the latch and the striker are mounted to the trunk hinges on both sides to form a pair, respectively, thereby providing uniform fastening force to both sides and further the wire for operating the locking of the latch is connected to a rod thereby operating simultaneously the latches on both sides.

Furthermore, the latch is mounted to a package tray (having a closed section in which a space is formed) and both sides of the latch are connected by the rod thereby the wire is arranged in a straight line to reduce poor product rate due to scattering of assembly thereof.

Additionally, the striker of the present invention has legs of different heights thereby to be engaged precisely with the latch without increasing a size thereof.

For convenience in explanation and accurate definition in the appended claims, the terms upper or lower, front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A locking structure for opening and closing a trunk space, comprising:
a trunk lid to open and close a trunk space in accordance;
a trunk hinge including one end connected to a vehicle body, the trunk lid being connected to another end of the trunk hinge;
a striker connected to the trunk hinge; and
a latch for restricting the movement of the striker when the striker is fastened, wherein the latch is mounted to a location where the latch is fastened to the striker while the trunk lid connected to a vehicle body is closed.

2. The locking structure of a trunk lid of claim 1, wherein the latch is mounted to a lower surface of a package tray, forming a part of a vehicle body, which is arranged at a front of the trunk lid at an upper side of a trunk space.

3. The locking structure of a trunk lid of claim 1, wherein the latch and the striker are arranged to form a pair wherein the pair of the latch and the striker is mounted to two trunk hinges arranged on both sides of the trunk lid, respectively, and the latches are connected to both sides of a rod connected to the wire, respectively, and the latches are controlled simultaneously to be fastened and released by pulling the wire.

4. The locking structure of a trunk lid of claim 3, wherein the striker has a bending bar shape wherein it includes two legs ends of which are connected to the trunk hinge and a fastening part that is connected to the respective leg and engaged with the latch, and the heights of the legs are different each other such that the fastening part is engaged vertically with the latch.
